(19) United States
(12) Patent Application Publication
(10) Pub. No.: US 2014/0053931 A1
(43) Pub. Date: Feb. 27, 2014

(54) Multiple port stopcock valve

(71) Applicant: NORDSON, INC., Westlake, OH (US)

(72) Inventor: Carl T. Whitaker, Berthoud, CO (US)

(73) Assignee: Nordson, Inc., Westlake, OH (US)

(21) Appl. No.: 13/804,176

(22) Filed: Mar. 14, 2013

Related U.S. Application Data
(60) Provisional application No. 61/692,614, filed on Aug. 23, 2012.

(51) Int. Cl. F16K 11/085

(52) U.S. Cl. CPC F16K 11/0853
USPC 137/625.17

(57) ABSTRACT

A multiple port valve has a valve body and a directional component. The valve body is formed as an annular cylinder with a plurality of ports extending from an outer surface and a cavity defined by an inner surface. The directional component is positioned in the cavity and defines a fluid path that provides fluid communication between combinations of two or more of the plurality of ports depending upon an angular orientation of the directional within the cavity.

### CROSS REFERENCE TO RELATED APPLICATIONS

This application claims the benefit of priority pursuant to 35 U.S.C. §119(e) of U.S. provisional application No. 61/692,614 filed 23 Aug. 2012 entitled “Multiple port stopcock valve,” which is hereby incorporated herein by reference in its entirety

### BACKGROUND

Typical low pressure or low volume multiple port stop cock or plug valve designs consist of a press fit bushing or plug housed inside a molded body with two to four fluid entry or exit ports. Each of the entry ports may be associated with a different fluid media, and each of the exit ports may be associated with a different application. To connect an entry port and an exit port, the plug is rotated within the body until a passageway extending through the plug is aligned with the entry port and the exit port.

Generally, the plug acts as the seal between the plug and the body to prevent leakage between ports. However, in many multiple port designs, the plug does not create a sufficient seal with the body and fluid media associated with an entry port of the body passes between the plug and the body and enters other ports of the body, possibly contaminating a different fluid media associated with the other ports. Fluid media contamination is undesirable and may be catastrophic, and thus improved multiple port valve designs are needed.

The information included in this Background section of the specification, including any references cited herein and any description or discussion thereof, is included for technical reference purposes only and is not to be regarded subject matter by which the scope of the invention is to be bound.

### SUMMARY

A new design for a multiple port valve is disclosed herein. The valve is composed of two primary components, a manifold housing or valve body and a plug or directional component that is rotatable relative to the valve body. In one implementation, the valve body is a short-walled, annular cylinder formed of a co-polymer or other suitable plastic material. A plurality of inlet or outlet ports may extend either as an outward projection of a cord of the cylinder, radially, or tangentially from an external sidewall of the cylinder.

In one implementation, the directional is a cylindrical component formed of a co-polymer or other suitable plastic material. The directional rotates within the valve body to selectively permit or restrict fluid flow through the multiple port valve. The directional may be rotated manually by a handle, knob, or lever or driven electrically by a motor coupled to the directional.

The directional may include a passageway that extends through the directional from at least one inlet to at least one outlet. In one implementation, the directional includes a single inlet and a single outlet. The inlet may be designed to be in continuous fluid communication with an inlet port of the valve body throughout various angular orientations of the directional relative to the valve body. In this implementation, the directional may be selectively rotated within the valve body to align the outlet of the passageway with a particular outlet port of the valve body, thereby allowing fluid flow through the valve body. In another implementation, the directional includes a plurality of inlets that converge into a common outlet. In this implementation, the angular position of the plurality of inlets and the outlet are designed to connect various combinations of inlet/outlet ports of the valve body.

In one implementation, a multiple port valve includes a valve body and a directional component. The valve body includes an outer circumferential wall, an inner circumferential surface, and a plurality of ports. The inner circumferential surface defines a cylindrical cavity surrounded by the valve body, and the inner circumferential surface has a plurality of openings. The plurality of ports extend outward from the outer circumferential wall, and each port defines a lumen that extends between one of the plurality of openings in the inner circumferential surface and an opening in a distal end of the respective port. The directional component is positioned in the cavity and has a sealing surface engaged with the inner circumferential surface to provide a fluid-tight seal between the directional component and the valve body. The directional component defines a passage that extends across an inner portion of the directional component and that provides fluid communication between combinations of two or more of the plurality of ports depending upon an angular orientation of the directional component within the cavity. The passage has opposed sidewalls that converge over at least a portion of the passage. The passage may be formed, for example, as a V-shaped funnel, a Y-shaped funnel, a “peace sign”, or three or more conduits that converge in fluid communication at inner ends and extend from a point of convergence to open in an outer surface of the directional component. If the passage is formed as the three or more conduits, the conduits may extend substantially radially outward from the point of convergence. Additionally or alternatively, the conduits may angularly separate from each other from the point of convergence.

In another implementation, a multiple port valve includes a valve body and a differential component. The valve body has an outer wall, an inner wall, an inner cylindrical cavity defined by the inner wall, and three or more ports extending from the outer wall that define respective conduits extending between openings in the outer wall and openings in distal ends of the ports. The directional component is positioned in the cavity and defines a fluid-flow pathway in an interior portion of the directional component. The fluid-flow pathway selectively provides fluid communication between combinations of two or more of the ports depending upon an angular orientation of the directional component within the cavity. The fluid-flow pathway may have an inlet that remains in fluid communication with one of the three or more ports throughout an angular operating range. The fluid-flow pathway may have an outlet that intermittently aligns with individual ports of the three or more ports throughout the angular operating range. The fluid-flow pathway may converge from the inlet towards a centerline of the directional component. The fluid-flow pathway may have a substantially uniform cross-sectional area from the centerline of the directional component towards the outlet. The fluid-flow pathway may converge from the centerline of the directional component towards the outlet. The fluid-flow pathway may include three inlet pathways that converge into a common outlet pathway.

In a further implementation, a multiple port valve includes a valve body and a directional component. The valve body has a cylindrical inner wall that defines an inner cavity. The valve body defines a plurality of lumens extending through the inner wall and opening to the inner cavity. The valve body may include a mounting ear extending from an outer sidewall of the valve body. The directional component is rotatably positioned in the inner cavity and includes an outer surface that is press fit into the inner cavity. The outer surface conforms to the shape of the inner wall of the valve body to create a fluid-tight seal between the directional component and the valve body. The directional component defines a fluid passage extending through the directional component and opening through the outer surface of the directional component. The fluid passage selectively provides fluid communication between two or more of the plurality of lumens depending upon a rotational orientation of the directional component relative to the valve body. The directional component may include multiple inwardly-deformable segments that at least partially axially secure the directional component to the valve body. The directional component may include a keyed portion configured to engage a tool or implement to facilitate rotating the directional component relative to the valve body. The directional component may define an interior cavity, and the fluid passage may be defined by a fluid passage body that extends through the interior cavity and separates the interior cavity into two sub-cavities opening to opposing ends of the directional component. The valve body and the directional component may be formed from plastic, resulting in a plastic-to-plastic seal between the inner wall of the valve body and the outer surface of the directional component.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

FIG. 1A is an elevation view of an implementation of a multiple port valve.

FIG. 1B is a bottom isometric view of the multiple port valve of FIG. 1A.

FIG. 2A is a top isometric exploded view of the multiple port valve of FIG. 1A.

FIG. 2B is a bottom isometric exploded view of the multiple port valve of FIG. 1A.

FIG. 3 is an isometric view of a first embodiment of a directional component.

FIG. 4 is a rear isometric view of the directional component of FIG. 3.

FIG. 5 is a section view of the directional component of FIG. 3 taken along the line 5-5 as shown in FIG. 3.

FIG. 6 is a section view of the directional component of FIG. 3 taken along the line 6-6 as shown in FIG. 3.

FIG. 7 is a section view of the directional component of FIG. 3 taken along the line 7-7 as shown in FIG. 3.

FIG. 8 is a section view of the directional component of FIG. 3 taken along the line 8-8 as shown in FIG. 4.

FIG. 9 is a front elevation view of the directional component of FIG. 3.

FIG. 10 is a side elevation view of the directional component of FIG. 3.

FIG. 11 is an isometric view of a first embodiment of a valve body.

FIG. 12 is front elevation view of the valve body of FIG. 11.

FIG. 13 is a section view of the valve body of FIG. 25 taken along line 13-13 as shown in FIG. 12.

FIG. 14 is an isometric view of a first implementation of a multiple port valve.

FIG. 15 is a top view of the multiple port valve of FIG. 14.

FIG. 16 is a section view of the multiple port valve of FIG. 14 taken along the line 16-16 as shown in FIG. 15.

FIG. 17 is a side elevation view of the multiple port valve of FIG. 14.

FIG. 18A is a section view of the multiple port valve of FIG. 14 taken along the line 18A-18A as shown in FIG. 17. FIG. 18A depicts the directional in a first position in which the inlet port is in fluid communication with the first outlet port.

FIG. 18B is a section view of the multiple port valve of FIG. 14 taken along the line 18B-18B as shown in FIG. 17. FIG. 18B depicts the directional in a second position in which the inlet port is in fluid communication with the second outlet port.

FIG. 18C is a section view of the multiple port valve of FIG. 14 taken along the line 18C-18C as shown in FIG. 17. FIG. 18C depicts the directional in a third position in which the inlet port is in fluid communication with the third outlet port.

FIG. 18D is a section view of the multiple port valve of FIG. 14 taken along the line 18D-18D as shown in FIG. 17. FIG. 18D depicts the directional in an intermediate position in which the inlet port is not in fluid communication with the first, second, or third outlet ports.

FIG. 19 is an isometric view of a second embodiment of a directional member.

FIG. 20 is a rear isometric view of the directional member of FIG. 19.

FIG. 21 is an isometric section view of the directional member of FIG. 19 taken along line 21-21 as shown in FIG. 19.

FIG. 22 is an isometric section view of the directional member of FIG. 19 taken along line 22-22 as shown in FIG. 19.

FIG. 23 is a front elevation view of the directional member of FIG. 19.

FIG. 24 is a side elevation view of the directional member of FIG. 19.

FIG. 25 is an isometric view of a third embodiment of a directional.

FIG. 26 is a top plan view of the directional of FIG. 25.

FIG. 27 is a side elevation view of the directional of FIG. 25.

FIG. 28 is a side elevation view of the directional of FIG. 25 with a modified lower portion.

FIG. 29 is a front elevation view of a fourth embodiment of a directional structure.

FIG. 30 is a side elevation view of the directional structure of FIG. 29.

FIG. 31 is an isometric section view of the directional structure of FIG. 29 taken along the line 31-31 as shown in FIG. 30.

FIG. 32 is an isometric section view of the directional structure of FIG. 29 taken along the line 32-32 as shown in FIG. 31.

FIG. 33 is an isometric view of a second embodiment of a valve body.

FIG. 34 is a top plan view of the valve body of FIG. 33.

FIG. 35 is a section view of the valve body of FIG. 33 taken along the line 35-35 as shown in FIG. 34.

FIG. 36 is an isometric view of a second implementation of a multiple port manifold valve.

FIG. 37 is a top plan view of the multiple port manifold valve of FIG. 36.

FIG. 38 is a section view of the multiple port manifold valve of FIG. 36 taken along the line 38-38 as shown in FIG. 37.

FIG. 39 is a front elevation view of the multiple port manifold valve of FIG. 36.

FIG. 40A is a section view of the multiple port manifold valve of FIG. 36 taken along the line 40A-40A as shown in FIG. 39. FIG. 40A depicts the directional in a first position in which the inlet port is in fluid communication with the first outlet port.

FIG. 40B is a section view of the multiple port manifold valve of FIG. 36 taken along the line 40B-40B as shown in FIG. 39. FIG. 40B depicts the directional in a second position in which the inlet port is in fluid communication with the second outlet port.

FIG. 40C is a section view of the multiple port manifold valve of FIG. 36 taken along the line 40C-40C as shown in FIG. 39. FIG. 40C depicts the directional in a third position in which the inlet port is in fluid communication with the third outlet port.

FIG. 41 is an isometric view of a third implementation of a multiple port valve.

FIG. 42 is a top plan view of the multiple port valve of FIG. 41.

FIG. 43 is a section view of the multiple port valve of FIG. 41 taken along the line 43-43 as shown in FIG. 42.

FIG. 44 is a section view of the multiple port valve of FIG. 41 taken along the line 44-44 as shown in FIG. 42.

### DETAILED DESCRIPTION

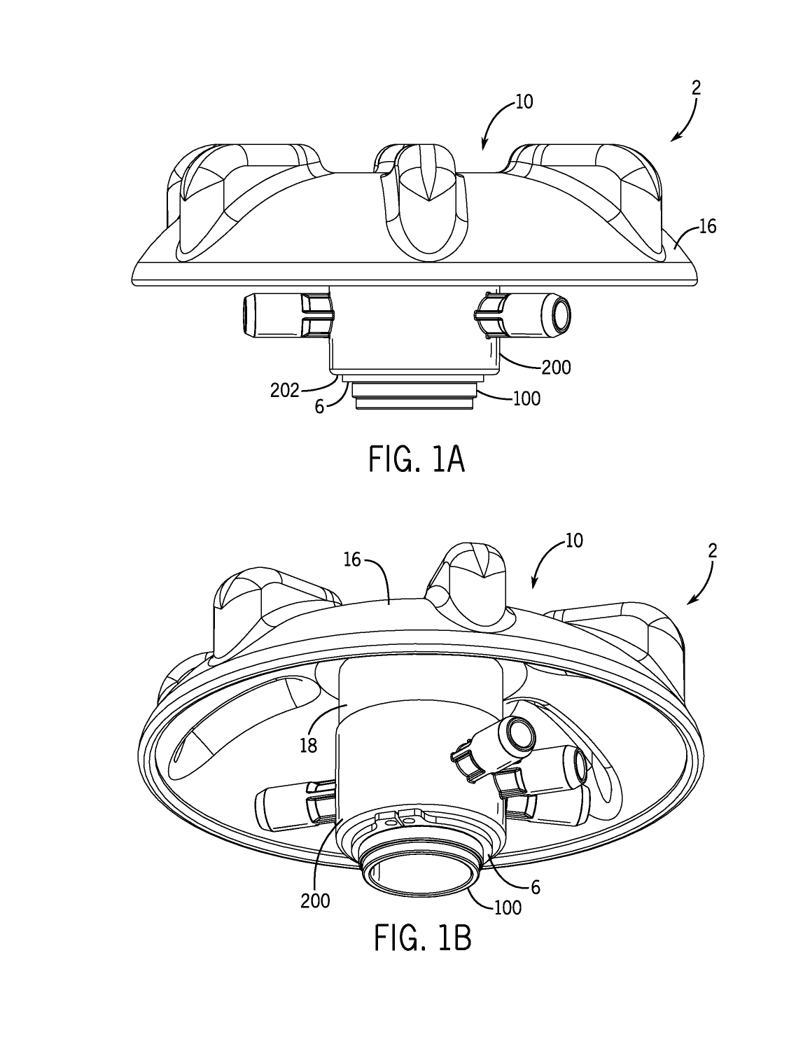

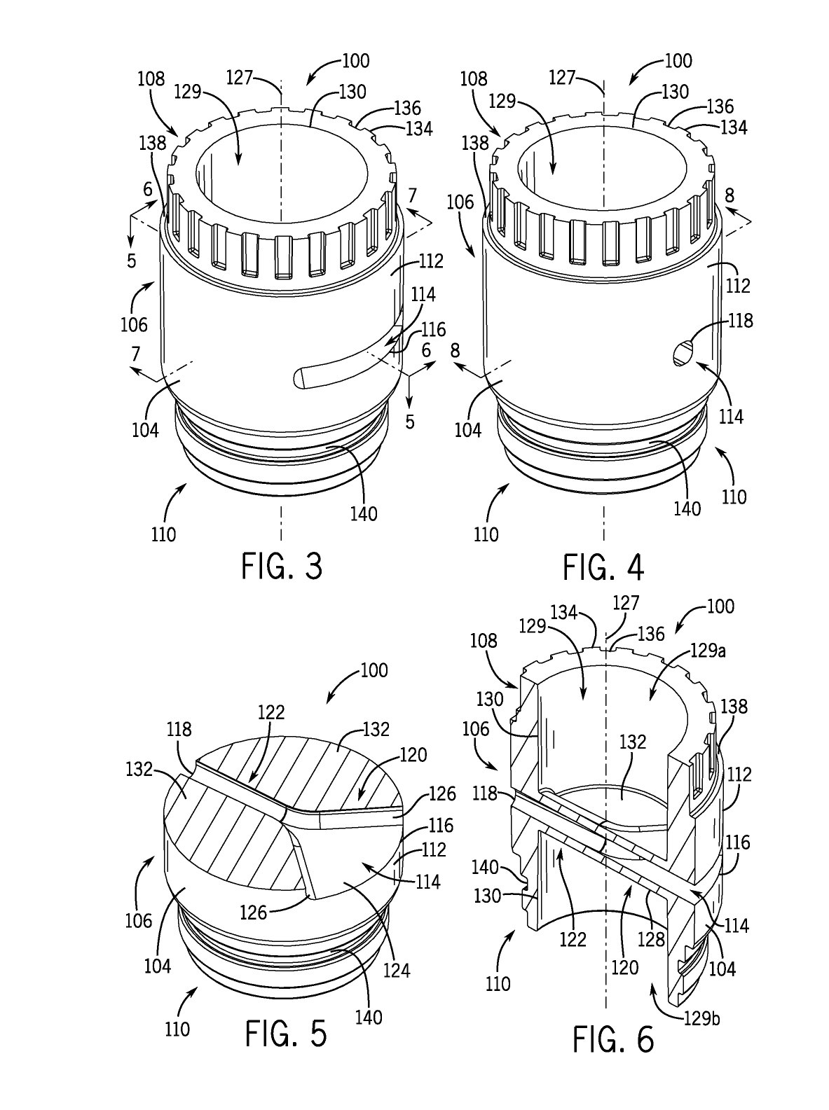

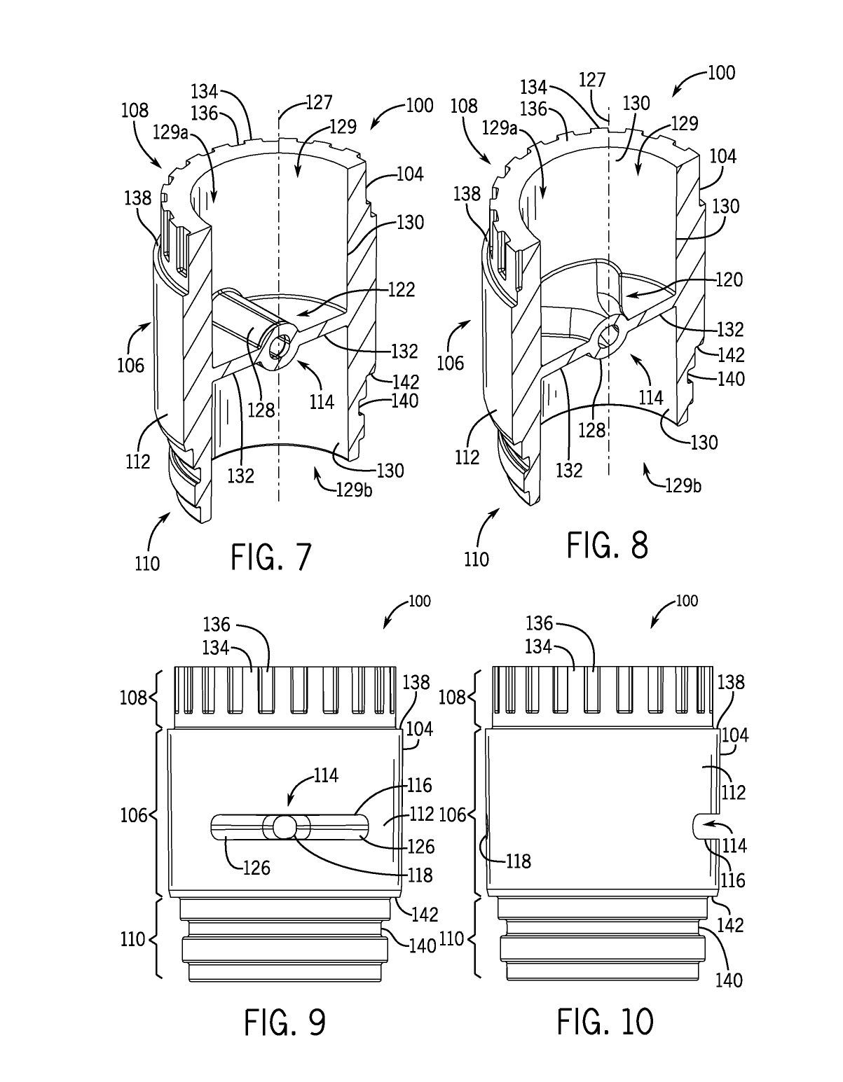

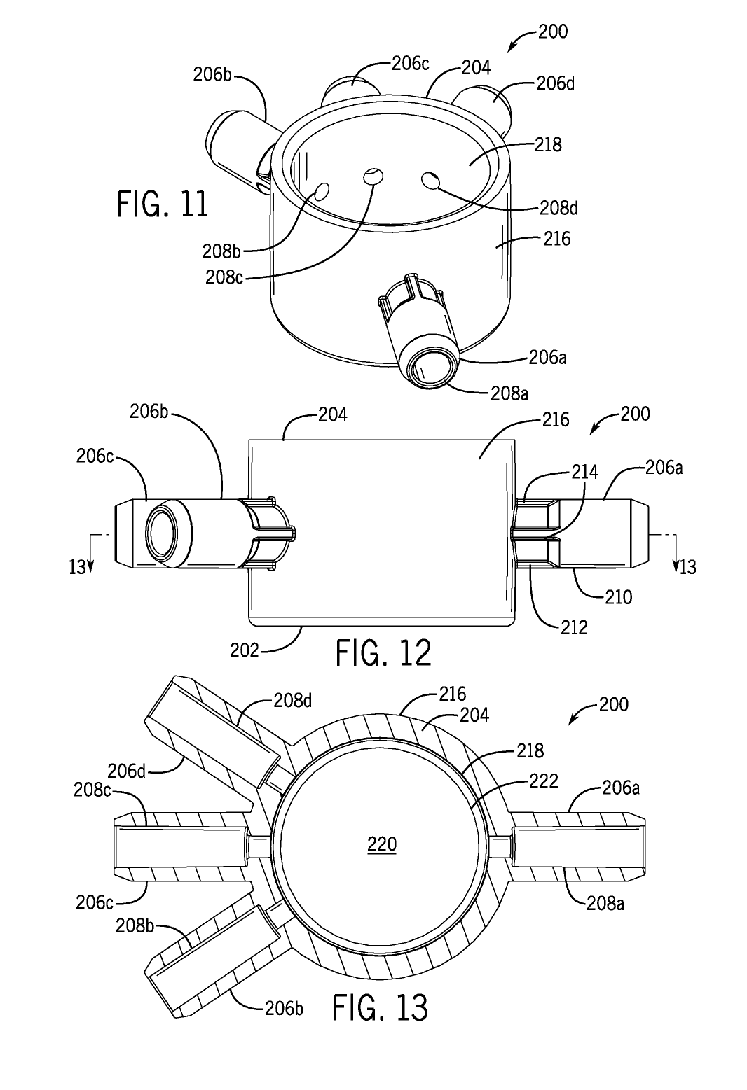

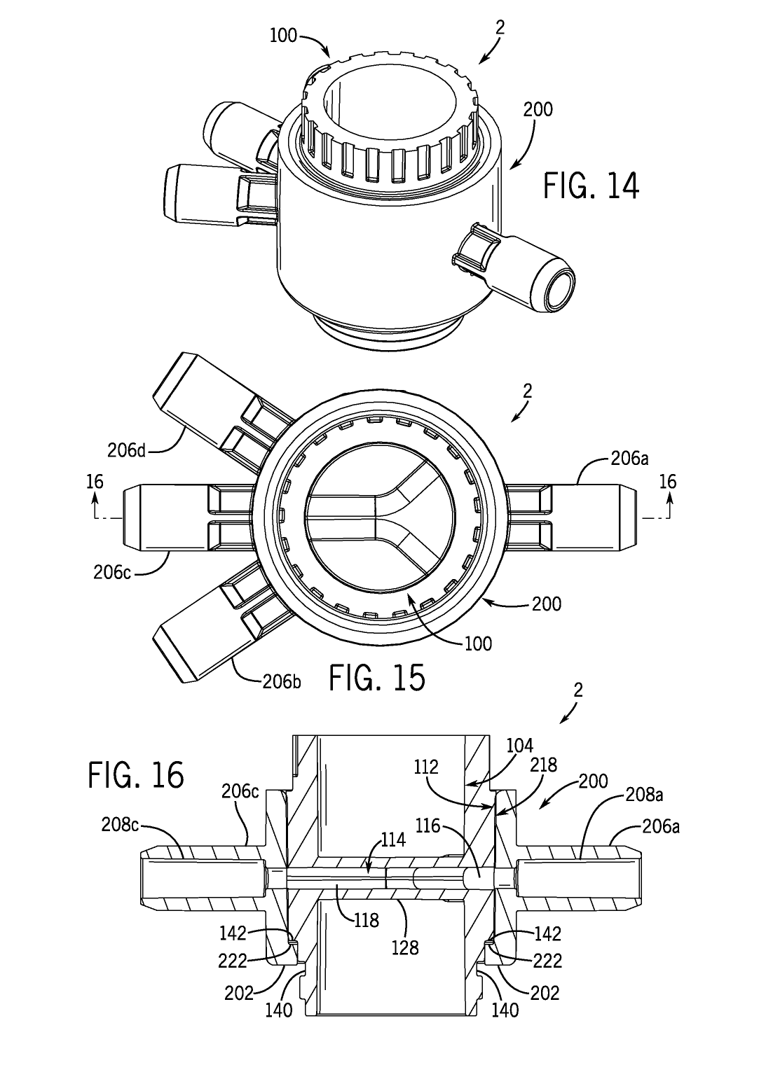

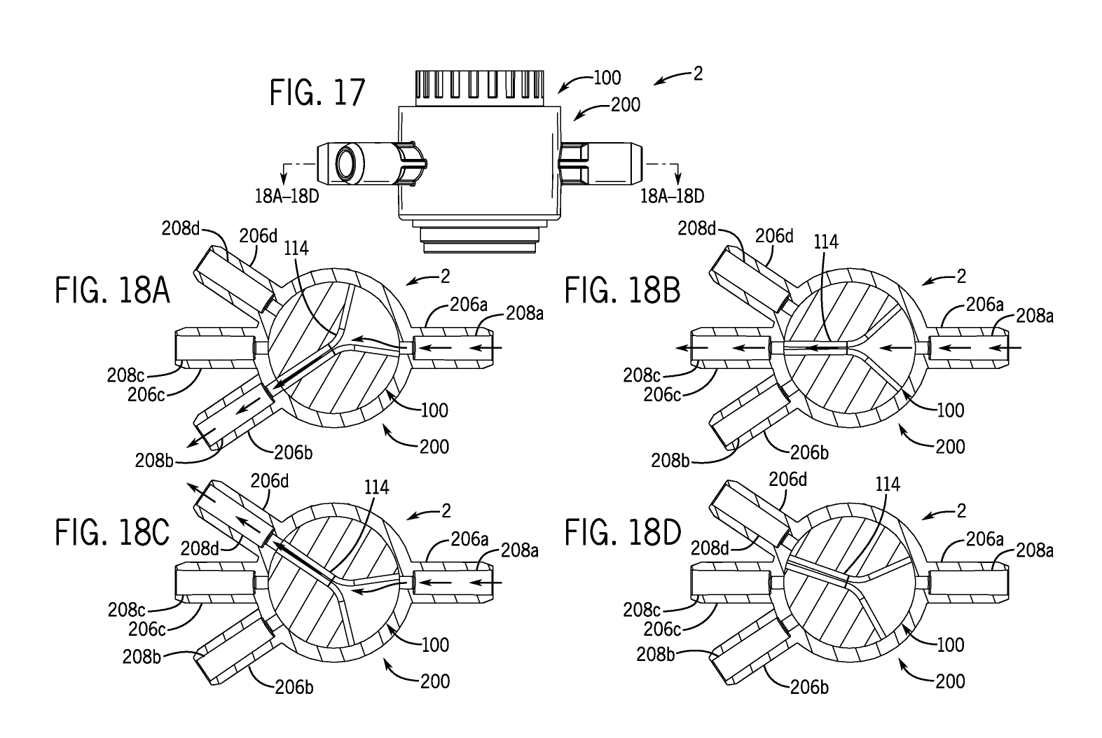

FIGS. 1A-18D depict an implementation of a multiple port valve 2 for selectively altering the fluid flow between combinations of two or more ports. The multiple port valve 2 is composed of two major components: a directional 100 and a valve body 200. The structure of the directional 100 is presented in greater detail in FIGS. 3-10, and the structure of the valve body 200 is provided in greater detail in FIGS. 11-13. The assembled multiple port valve 2, including the directional 100 and the valve body 200, is depicted in FIGS. 14-18D.

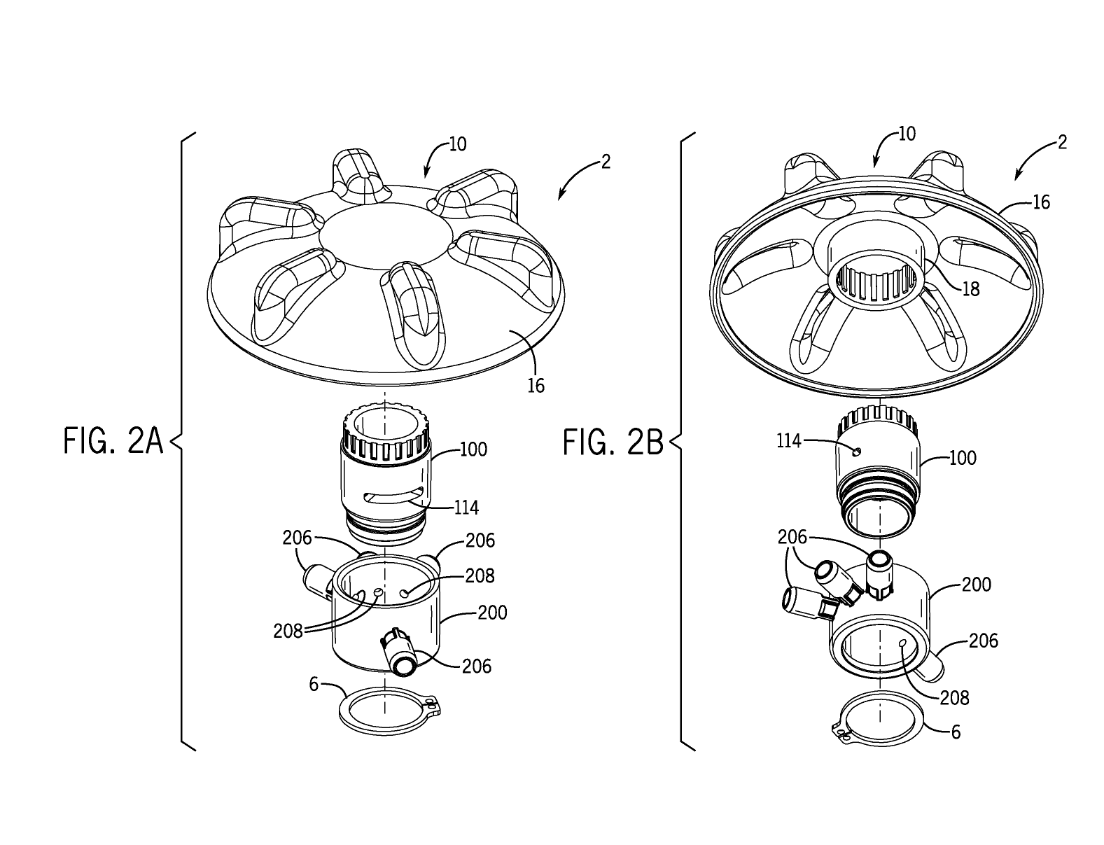

In the implementation of the multiple port valve 2 depicted in FIGS. 1A-2B, the directional component 100 fits within the valve body 200 and is secured to the valve body 200 by a retaining ring 6. The retaining ring 6 may fit snugly against a bottom surface 202 of the valve body 200 to retain the axial position of the directional 100 relative to the valve body 200 so that a passageway 114 formed in the directional 100 (see FIGS. 2A-2B) vertically coincides with a plurality of apertures or lumens 208 formed in the valve body 200. The directional 100 may be rotatable within the valve body 200 to selectively couple various combinations of the lumens 208.

To rotate the directional 100 within the valve body 200, a handle, knob, lever, or any other suitable device may be used. For example, in FIGS. 1A-2B, the multiple port valve 2 includes a selector or knob 10 for selectively turning the directional 100 relative to the valve body 200. In particular, the knob 10 includes a cover 16 and a sleeve 18 extending from a lower surface of the cover 16. The sleeve 18 is keyed and includes an inner receptacle sized to receive a complementary keyed portion of the directional 100 so that rotating the knob 10 rotates the directional 100. The complementary keying structure of the knob 10 and the directional 100 comprises splines formed on an interior surface of the sleeve 18 and on an exterior surface of the directional 100. In other configurations, the sleeve 18 may include exterior splines and the directional 100 may include interior splines. Additionally or alternatively, other keying structures may be used to rotatably link the directional 100 to a handle, knob, lever, or any other suitable device. Although not depicted, the knob 10 may include positioning features configured to indicate the position of the directional 100 relative to the valve body 200. For example, the knob 10 may include a ball detent configured to provide tactile and/or audible clicks as the directional 100 moves to different angular positions relative to the valve body 200.

The directional 100 may be selectively dimensioned and formed from a softer material than the valve body 200 so that the directional 100 can be interference, or press, fit into an inner cavity of the valve body 200. In one implementation, the directional 100 and the valve body 200 are formed from plastic. In this implementation, once inserted, the directional 100 is compressed and conforms to the shape of the valve body 200, resulting in a plastic-to-plastic seal between the components. A lubricant, such as a silicon grease, may be used to ease rotation of the directional 100 relative to the valve body 200 and to enhance the seal between the components. Exemplary directional 100 materials include various polymers, such as polyethylene and polypropylene. Exemplary valve body 200 materials include various polymers, such as polycarbonate and acrylic.

Referring to FIGS. 3-10, the directional 100 may include a substantially cylindrical body 104 having a fluid passage portion 106, a mounting crown 108 integrally formed on one end of the fluid passage portion 106, and a valve body connection portion 110 integrally formed on the other end of the fluid passage portion 106. The fluid passage portion 106 may include a circumferential sealing surface 112 designed to sealingly engage a complementary inner surface 218 of the valve body 200 (see FIGS. 11 and 13) to provide a fluid-tight seal between the directional 100 and the valve body 200.

The fluid passage portion 106 also may include a fluid passage 114 extending between an inlet 116 formed in the sealing surface 112 and an outlet 118 formed in an opposing side of the sealing surface 112. The inlet 116 may define an elongated, horizontal slot in the sealing surface 112, as shown in FIG. 3. The outlet 118 may define a substantially circular or elliptical opening in the sealing surface 112, as shown in FIG. 4. As the directional 100 is turned within the valve body 200, the inlet 116 may provide fluid communication from an inlet port 206a defining an inlet lumen 208a and extending from the valve body 200 through a range of angular orientations (see FIGS. 18A-18D), while the outlet 118 may align with individual outlet ports 206b, 206c, 206d defining respective outlet lumens 208b, 208c, 208d associated with the valve body 200 in specific angular orientations to selectively couple the inlet port 206a with one of the outlet ports 206b, 206c, 206d. In other words, the inlet 116 of the directional 100 may remain in fluid communication with the inlet port 206a of the valve body 200 throughout an angular operating range, while the outlet 118 of the directional 100 may intermittently align with individual outlet ports 206b, 206c, 206d of the valve body 200.

With reference to FIGS. 5-9, the fluid passage 114 may decrease in cross-sectional area or converge from the inlet 116 toward the outlet 118. The fluid passage 114 may be generally Y-shaped and extend transversely through the directional 100 between the inlet 116 and the outlet 118. The Y-shaped fluid passage 114 may be understood as composed of two sections: a fan-shaped inlet section 120 and a leg or stem-shaped outlet section 122.

The fan-shaped inlet section 120 may include approximately planar top and bottom surfaces 124 spatially separated from each other to define a height of the inlet section 120. The top and bottom surfaces 124 may be parallel to one another to define a substantially uniform height or alternatively may reside in intersecting planes so that the height of the inlet section 120 varies from the inlet 116 to the stem section 122. The fan-shaped inlet section 120 also may include sidewalls 126 that converge toward each other as the fan-shaped section 120 transitions from the inlet 116 to the stem section 122. Each sidewall 126 may extend radially inward from the inlet 116 in an approximately linear path, an arcuate or curved path, or both. In addition, each sidewall 126 may have an arcuate or substantially semi-circular cross-sectional shape that is complementary to the shape of at least one of the lumens 208 extending through the ports 206 of the valve body 200. The arcuate or substantially semi-circular cross-sectional shape of each sidewall 126 also may promote laminar fluid flow through the fluid passage 114. In other words, fluid particles flowing through the fluid passage 114 may move in substantially straight lines parallel to the sidewalls 126 with minimal lateral mixing or currents.

The leg or stem outlet section 122 may fluidically connect the fan-shaped inlet section 120 to the outlet 118. The stem section 122 may extend between the inlet section 120 and the outlet 118 in an approximately linear path, an arcuate or curved path, or both. In addition, the stem section 122 may have a circular or elliptical cross-sectional shape that is complementary to the shape of at least one of the lumens 208 extending through the ports 206 of the valve body 200. Although the transition of the fan-shaped section 120 into the stem shaped section 122 is depicted as substantially coinciding with a longitudinal axis or centerline 127 of the directional 100, the length of the sections 120, 122 may vary and thus the transition may occur at different locations within the directional 100. Also, in some configurations, the passage 114 does not pass through the longitudinal axis or centerline 127 of the directional 100.

The directional 100 depicted in FIGS. 3-10 has a substantially hollow interior 129 and thus the fluid passage 114 is housed within a passage body 128 that extends transversely through the hollow interior 129 of the directional 100. The fluid passage housing or body 128 may be integrally formed with the inner wall 130 and may pass through a longitudinal axis or centerline 127 of the directional 100. In some configurations, the fluid passage body 128 does not pass through the longitudinal axis or centerline 127 of the directional 100. In these configurations, the body 128 may form a chord extending linearly between different locations on the inner wall 130 of the directional 100 or an arcuate structure passing around the centerline 127 of the directional 100 and connecting the inlet 116 to the outlet 118.

With reference to FIGS. 6-8, the fluid passage body 128 has an approximately uniform wall thickness and thus the exterior surface of the body 128 is substantially identical to the shape of the fluid passage 114, which is defined by an inner surface of the body 128 except for the portion of the fluid passage 114 that passes through the sidewall of the directional 100. In alternative designs, the wall thickness of the body 128 varies and thus the external shape of the body 128 is different from the shape of the fluid passage 114. For example, the body 128 may have substantially flat top and bottom surfaces that extend horizontally through the hollow interior 129 of the directional 100.

Still referring to FIGS. 6-8, the directional 100 may include a transverse or horizontal shelf 132 that may extend between, and be integrally formed with, the fluid passage body 128 and the inner wall 130 of the directional 100. The shelf 132 provides rigidity to the body 128 and divides the internal space 129 of the directional 100 into an upper cavity 129a and a lower cavity 129b. The upper cavity 129a and the lower cavity 129b may open to opposite ends of the directional 100.

With reference to FIGS. 3-10, the mounting crown 108 may be integrally formed on one end of the fluid passage portion 106 and may provide an interface for a tool or implement to engage and rotate the directional 100 to selectively align the fluid passage 114 with the lumens 208 formed in the valve body 200. The mounting crown 108 may be splined with a plurality of alternating ridges 134 and grooves 136. The ridges 134 and grooves 136 may extend substantially parallel to the centerline 127 of the directional 100. The mounting crown 108 may transition into the sealing surface 112 via a shoulder 138. The shoulder 138 may provide an abutment surface for a tool or implement. In alternative configurations, the directional 100 may include other features for interfacing with a tool or implement. For example, the directional 100 may include a shaft receptacle configured to receive a shaft associated with the tool or implement. The shaft receptacle may be square, triangular, hexagonal, octagonal, elliptical, knurled, fluted, or any other keyed shape to interface with a tool or implement. Other suitable keying structures known in the art may be used to couple the directional 100 with a tool or implement.

With continued reference to FIGS. 3-10, the valve body connection portion 110 of the directional 100 may be integrally formed on an opposing end of the fluid passage portion 106 relative to the mounting crown 108. The valve body connection portion 110 generally provides an interface for axially connecting the directional 100 to the valve body 200. The valve body connection portion 110 may include an annular groove or recess 140 formed in an outer surface of the connection portion 110. The valve body connection portion 110 may transition into the fluid passage portion 106 at a shoulder 142, which may extend transversely to the longitudinal axis 127 of the directional 100 between the smaller diameter valve body connection portion 110 and the larger diameter fluid passage portion 106.

Referring to FIGS. 11-13, the valve body 200 may include a central structure, referred to herein as a valve hull 204, formed as a hollow cylinder. A plurality of ports 206 may project from an exterior wall 216 of the valve hull 204 and may be utilized to connect the valve body 200 to tubing for transmitting fluid to and from the valve body 200. The plurality of ports 206 may include a barb configured to inhibit inadvertent detachment of the tubing from the plurality of ports 206. The exemplary valve body 200 includes four ports 206a-206d. For convenience in identification hereinafter, the inlet/outlet ports may be referred to as a first port 206a, a second port 206b, a third port 206c, and a fourth port 206d. In one exemplary implementation, the first port 206a is an inlet port, the second port 206b is an outlet port, the third port 206c is an outlet port, and the fourth port 206d is an outlet port. In some embodiments, the inlet port 206a and the outlet ports 206b-d may function as dual flow ports.

The ports 206a-206d may be arranged in any of a number of configurations. In the embodiment shown in FIGS. 11-13, the ports 206 extend radially outward from an outer sidewall 216 of the valve hull 204. A center axis extending through the lumens 208 of each of the ports 204 may be coplanar; in other embodiments the axes of the lumens 208 may not be coplanar.

Each of the ports 206a-206d may be formed with a straight shaft section 210 and a ribbed shaft section 212. Each ribbed shaft section 212 may include a plurality of ribs 214 extending along the central axis of the respective lumen 208 between the valve hull 204 and the straight shaft section 210. The ribbed shaft section 212 may assist in the reception and retention of tubing and provide structural reinforcement at the interface of the ports 206a-206d with the valve hull 204.

The valve body 200 may have an inner wall 218 that defines an interior cavity 220 sized to receive the directional 100. A lower portion of the inner wall 218 may extend into the cavity 220 to form an annular projection 222. The annular projection 222 may have a lower surface 202 that defines a lower end of the valve body 200.

To axially secure the directional 100 to the valve body 200, the valve body connection portion 110 may be inserted into an interior cavity 220 of the valve body 200 (see FIG. 13) until the shoulder 142 of the directional 100 abuts an annular protrusion 222 of the valve body 200 extending radially inward from an inner wall 218 of the valve body 200. The directional 100 may be dimensioned so that a portion of the valve body connection portion 110, including the annular recess 140, extends beyond the lower surface 202 of the valve body 200 (see FIG. 16). After inserting the directional 100 into the valve body 200, the retaining ring 6 may be placed in the annular recess 140. The retaining ring 6 may fit snugly against the lower surface 202 of the valve body 200 to axially retain the valve body 200 between the retaining ring 6 and the shoulder 142 of the directional 100, while allowing rotation of the directional 100 within the valve body 200.

Referring to FIGS. 14-18D, the multiple port valve 2 includes the directional 100, as shown in FIGS. 3-10, positioned within a cavity 220 defined by the valve body 200, as shown in FIGS. 11-13. The directional 100 may seat axially within the cavity 220 of the valve body 200.

The sealing surface 112 of the directional 100 may abut against the inner face or wall 218 of the valve body 200 to form a fluid-tight seal. The material of the directional 100 and the valve body 200 may be chosen in order to provide a low friction interface to allow for ease of rotation of the directional 100 within the valve body 200, while at the same time providing a fluid-tight seal between the two surfaces 112, 218. For example, in one configuration, the directional 100 may be formed from polyethylene or polypropylene and the valve body 200 may be formed from polycarbonate or acrylic. While the seal between the directional 100 and the valve body 200 may be designed to create a low friction interface, in some implementations a lubricant may also be used. For example, in some embodiments silicon grease is used to reduce the coefficient of friction between the components 100, 200. In some implementations, the directional 100 generally comprises a softer material than the valve body 200 and may be press-fit into the valve body 200. In these implementations, upon insertion of the directional 100 into the valve body 200, the sealing surface 112 of the directional 100 conforms to the shape of the inner wall 218 of the valve body 200 such that a seal interface is achieved between the directional 100 and the valve body 200 that prevents fluid media from escaping from or leaking out of the valve assembly.

A series of operational positions of the multiple port valve 2 based upon the respective angular orientation of the directional 100 relative to the valve body 200 are presented in FIGS. 18A-D. In FIG. 18A, a first position of the directional 100 within the valve body 200 is shown. In the first position, the directional 100 is rotated to provide fluid communication between the lumen 208a of the first port 206a and lumen 208b of the second port 206b through the fluid passage 114. As is shown, the lumens 208c, 208d for the third port 206c and the fourth port 206d are not in line with any portion of the fluid passage 114, but instead are positioned adjacent portions of the smooth circumferential sealing surface 112 of the directional 100, thereby preventing fluid flow into the lumens 208c, 208d of the third port 206c and the fourth port 206d.

FIG. 18B depicts the directional 100 rotated to a second position. In the second position, the lumen 208a of the first port 206a and the lumen 208c of the third port 206c are all in fluid communication with the Y-shaped fluid passage 114 of the directional 100. The lumens 208b, 208d for the second port 206b and the fourth port 206d are not in line with any portion of the fluid passage 114, but instead are positioned adjacent portions of the smooth circumferential sealing surface 112 of the directional 100, thereby preventing fluid flow into the lumens 208b, 208d of the second port 206b and the fourth port 206d.

FIG. 18C depicts the multiple port valve 2 in a third operational position. In the third position, the lumen 208a of the first port 206a and the lumen 208d of the fourth port 206d are all in fluid communication with the fluid passage 114 of the directional 100. The lumens 208b, 208c for the second port 206b and the third port 206c are not in line with any portion of the fluid passage 114, but instead are positioned adjacent portions of the smooth circumferential sealing surface 112 of the directional 100, thereby preventing fluid flow into the lumens 208b, 208c of the second port 206b and the third port 206c.

FIG. 18D depicts a fourth position of the directional 100 in the valve body 200 for the multiple port valve 2. In this fourth position, the first port 206a is in fluid communication with the fluid passage 114. However, there is no fluid flow through the lumen 208a of the first port 206a or through the passage 114 as the outlet 118 of the passage 114 is positioned against a solid section of the circumferential sealing surface 112, thereby preventing fluid flow through the multiple port valve 2.

In the multiple port valve 2 implementation depicted in FIGS. 1-18D, the directional 100 may be used to open a single outlet port 206b, 206c, or 206d at a time. For example, as the directional 100 is rotated, the inlet 116 of the Y-shaped fluid passage 114 may remain in fluid communication with the lumen 208a of the inlet port 206a. However, the outlet 118 of the fluid passage 114 may align with only one outlet port 206b, 206c, or 206d at a time. The outlet ports 206b, 206c, 206d not aligned with the outlet 118 are aligned with the sealing surface 112 and thus are fluidly sealed from connecting with any fluid flowing from the inlet port 206a via the inlet lumen 208a.

In a first position, the directional 100 opens the first fluid outlet port 206b, in a second position the directional 100 seals the first fluid outlet port 206b and opens the second outlet port 206c, and so on serially, such that every outlet port 206b-206d may be selected, but only one of the outlet ports 206b-206d is open at a time. Thus, in this particular implementation of a multiple port valve 2 three different fluid flow positions variously connecting combinations of two inlet/outlet ports are possible by rotating the directional 100 within the valve body 200. In alternate implementations, the fluid passage 114 in the directional 100 may be formed in a different pattern to provide for different fluid flow combinations between the inlet and outlet ports 206a-206d. Further, in other implementations there may be greater or fewer inlet/outlet ports positioned on the valve hull 204 of the valve body 200.

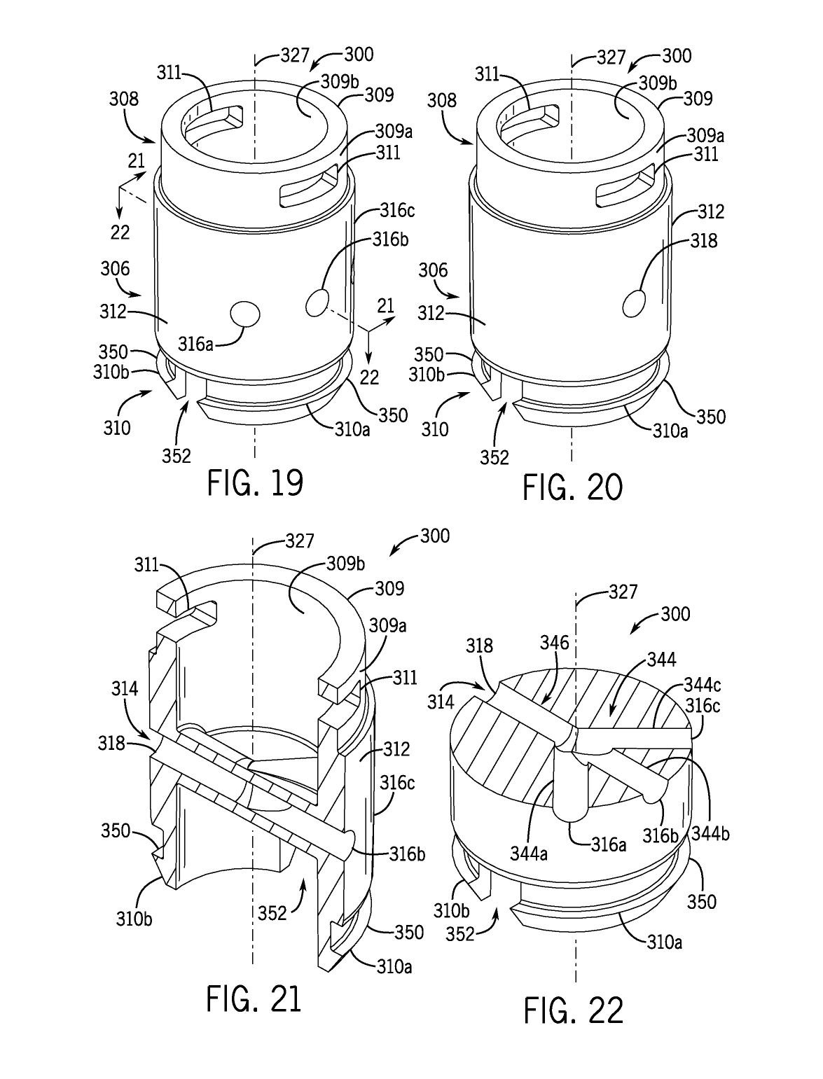

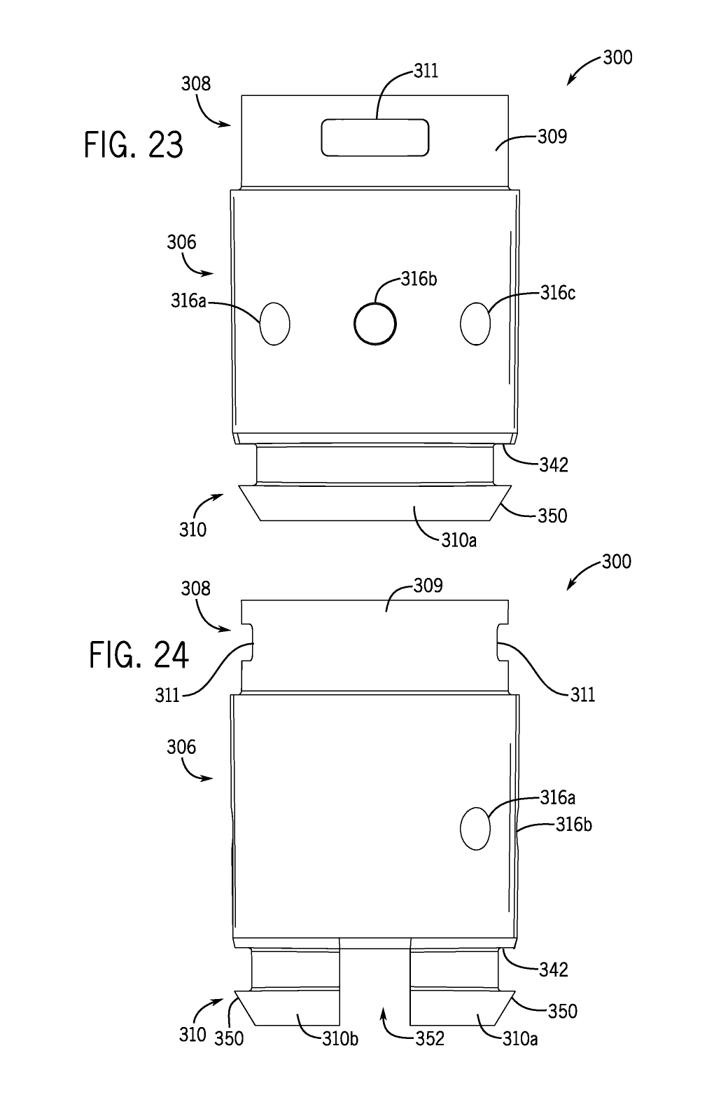

It should be understood that the shape of the fluid passage 114 depicted in FIGS. 3-10 is only one possible embodiment for a fluid passage shape. Other configurations are possible in order to accommodate greater or fewer inlet/outlet ports, alternative combinations of fluid communication between ports, or both (see, e.g., FIGS. 19-32). In addition, the width and height of the fluid passage 114 may be selected in order to provide adequate and constant fluid flow through the directional 100 or to satisfy any other functional considerations.

FIGS. 19-24 illustrate a second embodiment of a directional 300. The directional 300 includes a plurality of inlets 316 and a single outlet 318. Particularly, the directional 300 includes three inlets 316a, 316b, 316c. A fluid passage 314 connects the plurality of inlets 316 to the outlet 318 with multiple individual inlet branches 344. The branches 344 fluidly connect the plurality of inlets 316 to a common outlet path 346 that terminates at the outlet 318. The fluid passage 314 specifically includes three inlet branches 344a, 344b, 344c that originate at a single inlet 316a, 316b, 316c, respectively. The inlet branches 344a, 344b, 344c converge into the single outlet path 346 near the centerline 327 of the directional 300. In other words, at the intersection of the inlet branches 344a, 344b, 344c, the passage 314 is defined by opposing sidewalls of the outer inlet branches 344a, 344c that converge into the outlet path 346. The inlet branches 344 and the outlet path 346 each have approximately the same cross-sectional shape and dimensions. The fluid passage 314 generally resembles a “peace sign.”

The directional 300 also includes a different mounting crown 308 as compared to the first directional 100. The mounting crown 308 is a hollow cylindrical body 309 and includes a smooth outer and inner surface 309a, 309b. The mounting crown 308 also includes opposing openings 311 that may receive a corresponding feature of a tool or implement to facilitate turning of the directional 300 relative to the valve body 200.

The valve body connection portion 310 of the directional 300 also is modified as compared to the first directional 100. The connection portion 310 includes an annular protrusion or ridge 350 that extends outward from an outer wall of the connection portion 310. The annular ridge 350 may be formed as a frustum whereby an outer wall of the annular ridge 350 angles radially inward from the maximum radial protrusion of the annular ridge 350. To axially secure the directional 304 to the valve body 200, the valve body connection portion 110 is inserted into the interior cavity 220 of the valve body 200 until the shoulder 342 abuts the annular protrusion 222 extending radially inward from the inner wall 218 of the valve body 200 (see FIGS. 13 and 16).

During insertion of the directional 300 into the cavity 220 of the valve body 200, the annular ridge 350 of the directional 300 is deflected radially inward by the inner wall 218 of the valve body 200. As the shoulder 342 of the directional 300 approaches the corresponding annular protrusion 222 of the valve body 200, the annular ridge 350 snaps into place beneath the lower surface 202 of the valve body 200 to axially retain the annular protrusion 222 of the valve body 200 between the shoulder 342 and the annular ridge 350. The connection portion 310 may include a transverse cutout or gap 352 that separates the connection portion 310 into multiple downwardly extending segments 310a, 310b. In this configuration, the annular ridge 350 is discontinuous and thus is more easily deformable upon insertion into the interior cavity 220 of the valve body 200.

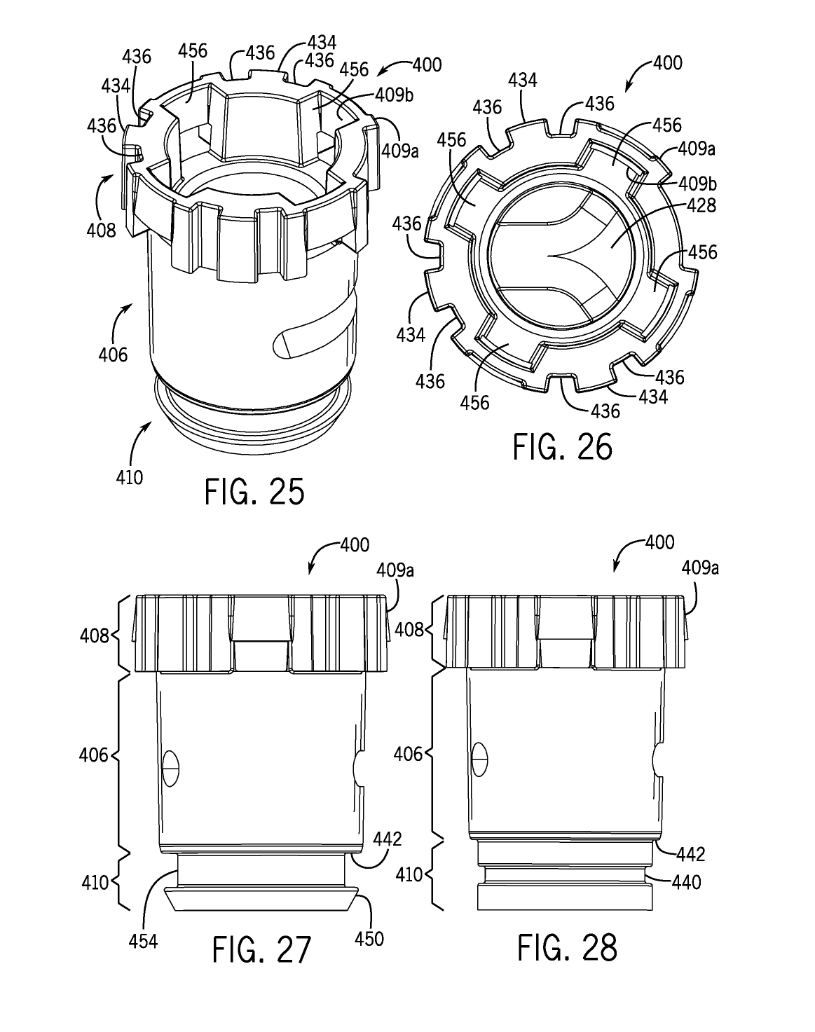

FIGS. 25-28 illustrate a third embodiment of a directional. The directional 400 includes a fluid passage portion 406 having a Y-shaped fluid passage body 428, as shown in FIG. 26, that is identical to the fluid passage body 128 of the directional 100. The directional 400 also includes a valve body connection portion 410 that is similar to the valve body connection portion 110 of the directional 100.

FIG. 27 illustrates one configuration of a valve body connection portion 410 having a single, continuous annular ridge 450 that extends 360 degrees around the circumference of the directional 400. The annular ridge 450 is spatially separated from the shoulder 442 to define a cylindrical wall 454 having a smaller diameter than the ridge 450 and the shoulder 442. The annular ridge 450 may be formed as a frustum whereby an outer wall of the annular ridge 450 angles radially inward from the maximum radial protrusion of the annular ridge 450. Upon connection of the directional 400 within the interior cavity 220 of the valve body 200, of the annular protrusion 222 of the valve body 200 is positioned adjacent to the cylindrical wall 454 and between the shoulder 442 and the annular ridge 450 to axially secure the directional 400 to the valve body 200, while allowing rotation of the directional 400 relative to the valve body 200. FIG. 28 depicts another configuration of a valve body connection portion 410 utilizing an annular recess 440 configured to seat the retaining ring 6.

The directional 400 also includes a mounting crown 408 that provides multiple connection options for a tool or implement. The mounting crown 408 may have a fluted exterior surface 409a having a plurality of alternating longitudinal ridges 434 and grooves 436. The inner surface 409b of the mounting crown 408 may have recessed areas 456. Thus, a tool or implement having a complementary keying pattern to that defined by the four recessed areas 456 may be utilized to turn the directional 400 relative to the valve body 200 to align a fluid path within a valve assembly.

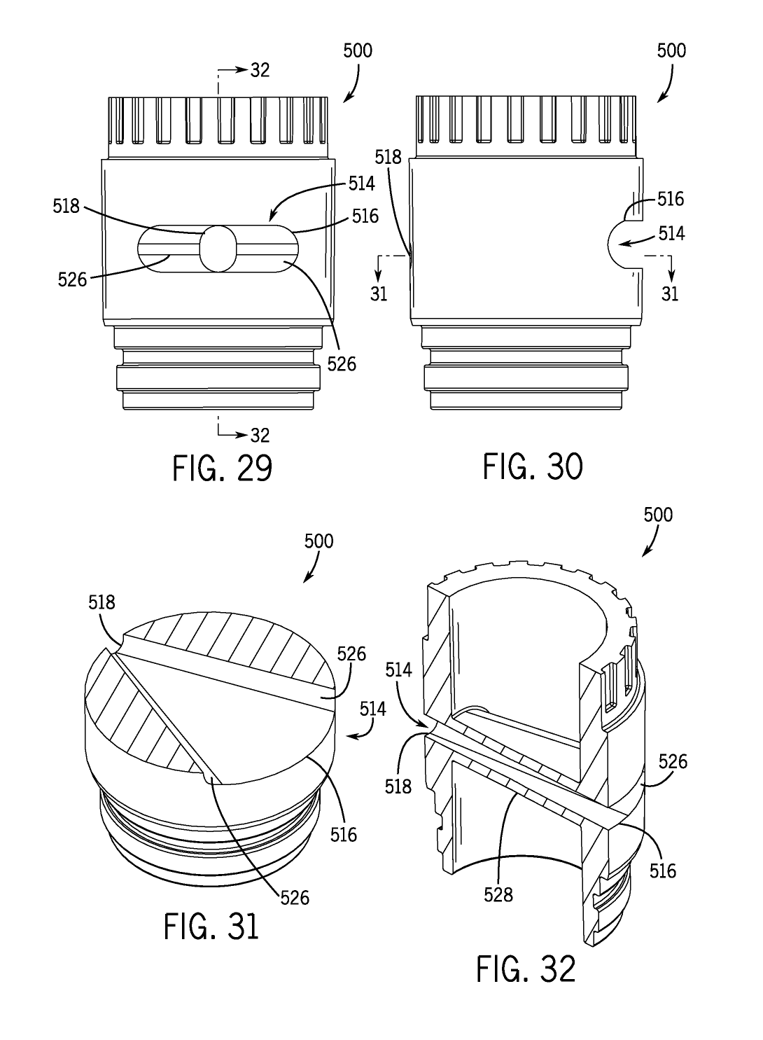

FIGS. 29-32 illustrate a fourth embodiment of a directional. The directional 500 is substantially identical to the directional 100 except that the fluid passage 514 and the corresponding fluid passage body 528 are generally V-shaped. As depicted in FIGS. 29 and 31, the fluid passage 514 includes sidewalls 526 that extend linearly between the larger width inlet 516 and the smaller width outlet 518. Generally, the fluid passage 514 decreases in cross-sectional area or converges from the inlet 516 toward the outlet 518. Similar to the sidewalls 126 of the directional 100, the sidewalls 526 of the directional 500 may have an arcuate or substantially semi-circular cross-sectional shape, which may promote laminar fluid flow through the fluid passage 514.

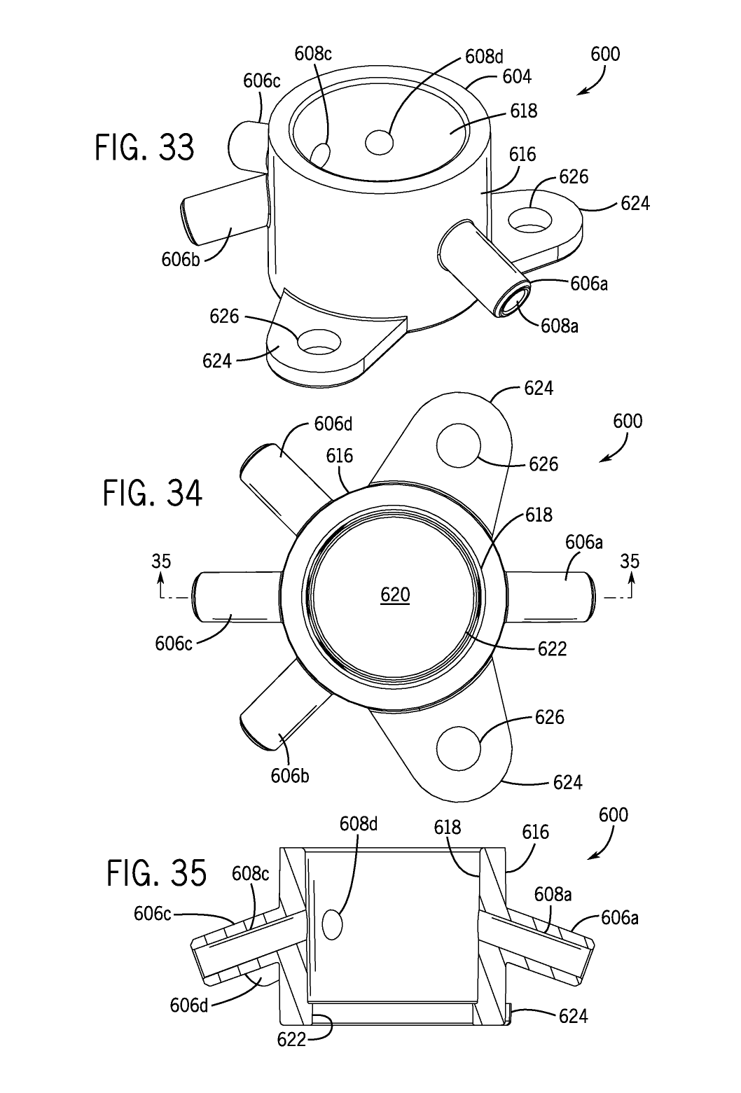

FIGS. 33-35 illustrate a second exemplary embodiment of a valve body. In this embodiment, the valve body 600 includes a pair of mounting wings or ears 624 extending from an outer sidewall of the valve hull 604. Each mounting ear 624 includes an aperture 626 that can be used to connect the valve body 600 to a support structure to provide stabilization to the valve body 600 during operation and during rotation of a directional 100, 300, 400, 500 within the central cavity 620 of the valve body 600. Additionally or alternatively, the apertures 626 may be used to stack multiple valve bodies on top of each other in alignment for packaging purposes or for control of a number of multiple port valves with a shaft associated with at least one of the valves. The valve body 600 also includes a plurality of ports 606 extending outward from an outer sidewall of the valve hull 604. The plurality of ports 606 may extend at a downward angle rather than in a common plane, which may reduce the total diameter of the valve body 600. This reduction in diameter may be desirable in areas with limited space and may more easily accommodate conduit connections in the limited space. The valve hull 604 may be formed of a substantially rigid polymer, co-polymer, or other plastic.

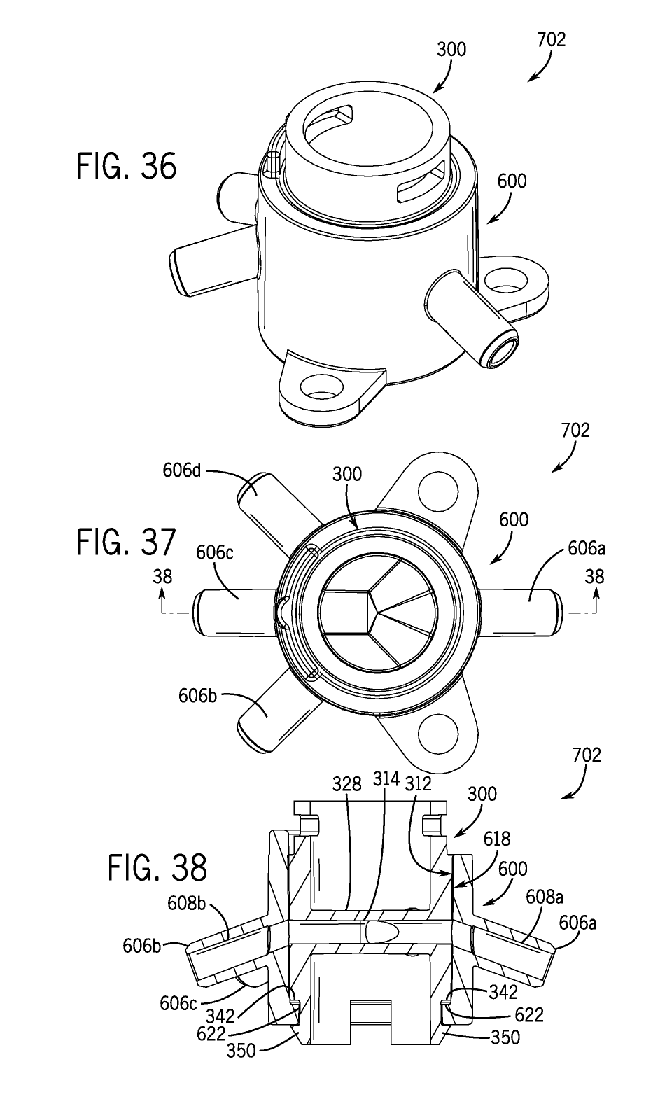

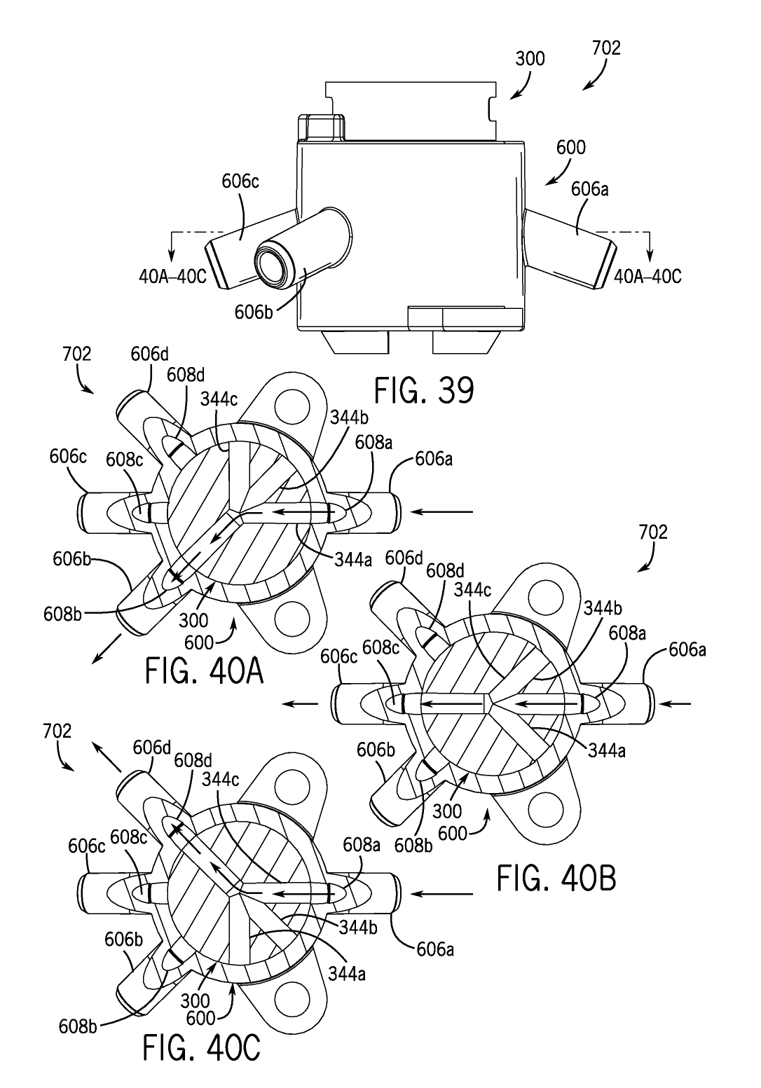

Referring to FIGS. 36-40, another implementation of a multiple port valve is provided. The multiple port valve 702 includes the directional 300, as shown in FIGS. 19-24, positioned within a cavity 620 defined by the valve body 600, as shown in FIGS. 33-35. The directional 300 seats axially within the cavity 620 of the valve body 600. The sealing surface 312 of the directional 300 abuts against the inner face or wall 618 of the valve body 600 to form a fluid tight seal.

The material of the directional 300 and the valve body 600 may be chosen in order to provide a low friction interface to allow for ease of rotation of the directional 300 within the valve body 600 while at the same time providing a fluid-tight seal between the two surfaces. For example, in one configuration, the directional 300 is formed from polyethylene or polypropylene, and the valve body 600 is formed from polycarbonate or acrylic. While the seal between the directional 300 and the valve body 600 may be designed to create a low friction interface, in some implementations a lubricant may also be used. For example, in some embodiments silicon grease is used to reduce the coefficient of friction between the components. The directional 300 may generally comprise a softer material than the valve body 600 and may be press fit into the valve body 600. Upon insertion of the directional 300 into the valve body 600, the sealing surface 312 of the directional 300 may conform to the shape of the inner wall 618 of the valve body 600 such that a seal interface is achieved between the directional 300 and the valve body 600 that prevents fluid media from escaping from or leaking out of the valve assembly.

A series of operational positions of the multiple port valve 702 based upon the respective angular orientation of the directional 300 relative to the valve body 600 are presented in FIGS. 40A-40C. In FIG. 40A, a first position of the directional 300 within the valve body 600 is shown. In the first position, the directional 300 is rotated to provide fluid communication between the lumen 608a of the first port 606a and the lumen 608b of the second port 606b through the fluid passage 314. As is shown, the lumens 608c, 608d for the third port 606c and the fourth port 606d are not in line with any portion of the fluid passage 314, but instead are positioned adjacent portions of the smooth circumferential sealing surface 312 of the directional 300, thereby preventing fluid flow into the lumens 608c, 608d of the third port 606c and the fourth port 606d.

FIG. 40B depicts the directional 304 rotated to a second position. In the second position, the lumen 608a of the first port 606a and the lumen 608c of the third port 606c are in fluid communication with the peace-sign shaped fluid passage 314 of the directional 300. The lumens 608b, 608d for the second port 606b and the fourth port 606d are not in line with any portion of the fluid passage 314, but instead are positioned adjacent portions of the smooth circumferential sealing surface 312 of the directional 300, thereby preventing fluid flow into the lumens 608b, 608d of the second port 606b and the fourth port 606d.

FIG. 40C depicts the multiple port valve 702 in a third operational position. In the third position, the lumen 608a of the first port 606a and the lumen 608d of the fourth port 606d are all in fluid communication with the fluid passage 314 of the directional 300. The lumens 608b, 608c for the second port 606b and the third port 606c are not in line with any portion of the fluid passage 314, but instead are positioned adjacent portions of the smooth circumferential sealing surface 312 of the directional 300, thereby preventing fluid flow into the lumens 608b, 608c of the second port 606b and the third port 606c.

In this implementation, the directional 300 may be used to open a single outlet port 606b, 606c, or 606d at a time. For example, as the directional 300 is rotated, one inlet 316a, 316b, or 316c of the fluid passage 314 aligns with the lumen 608a of the inlet port 606a as the outlet 318 of the fluid passage 314 aligns with one outlet port 606b, 606c, or 606d at a time. The outlet ports 606 not aligned with the outlet 318 are aligned with the sealing surface 312 and are fluidly sealed from connecting with any fluid flowing from the inlet port 606a via the inlet lumen 608a.

In a first position, the directional 300 opens the first fluid outlet port 606b, in a second position the directional 300 seals the first fluid outlet port 606b and opens the second outlet port 606c, and so on serially, such that every outlet port 606b-606d may be selected, but only one of the outlet ports 606b-606d is open at a time. Thus, in this particular implementation of a multiple port valve 702 three different fluid flow positions variously connecting combinations of two inlet/outlet ports are possible by rotating the directional 300 within the valve body 600. In alternate implementations, the fluid passage 314 in the directional 300 may be formed in a different pattern to provide for different fluid flow combinations between the inlet and outlet ports 606a-606d. Further in other implementations there may be greater or fewer inlet/outlet ports positioned on the valve hull 604 of the valve body 600.

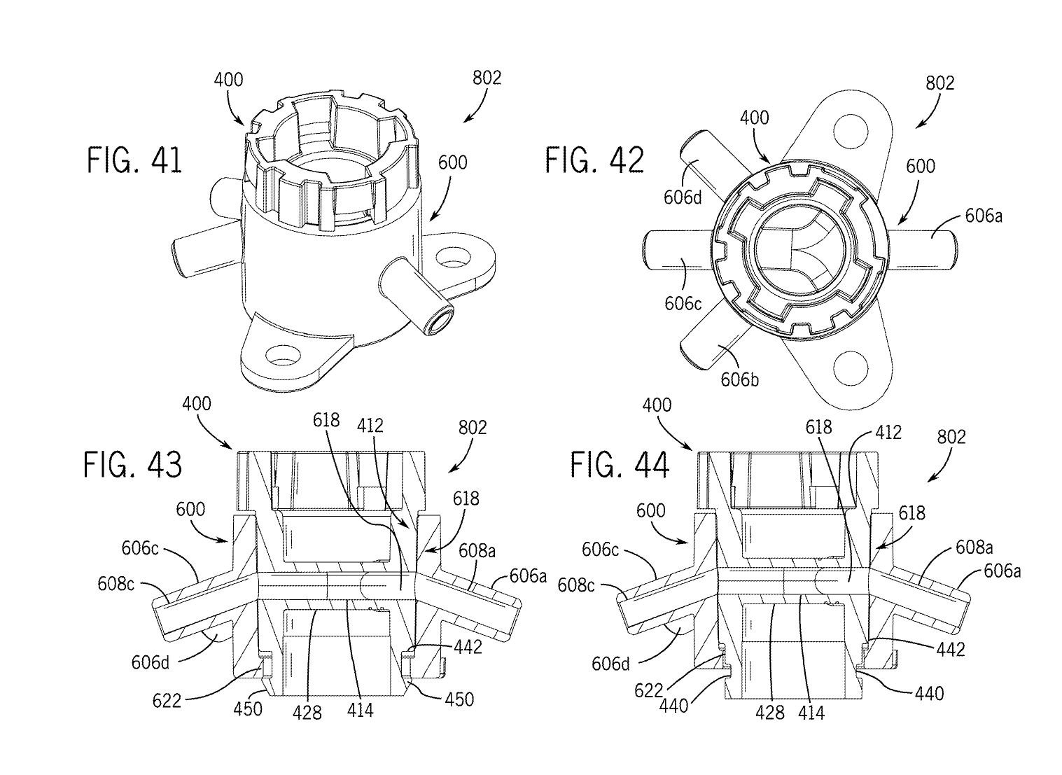

Referring to FIGS. 41-44, another implementation of a multiple port valve is provided. The multiple port valve 802 includes the directional 400, as shown in FIGS. 25-28, positioned within a cavity 620 defined by the valve body 600, as shown in FIGS. 33-35. The directional 400 seats axially within the cavity 620 of the valve body 600. The sealing surface 412 of the directional 400 abuts against the inner face or wall 618 of the valve body 600 to form a fluid tight seal.

The material of the directional 400 and the valve body 600 may be chosen in order to provide a low friction interface to allow for ease of rotation of the directional 400 within the valve body 600 while at the same time providing a fluid tight seal between the two surfaces. For example, in one configuration, the directional 400 is formed from polyethylene or polypropylene, and the valve body 600 is formed from polycarbonate or acrylic. While the seal between the directional 400 and the valve body 600 may be designed to create a low friction interface, in some implementations a lubricant may also be used. For example, in some embodiments silicon grease is used to reduce the coefficient of friction between the components.

The directional 400 may generally comprise a softer material than the valve body 600 and may be press-fit into the valve body 600. Upon insertion of the directional 400 into the valve body 600, the sealing surface 412 of the directional 400 may conform to the shape of the inner wall 618 of the valve body 600 such that a seal interface is achieved between the directional 400 and the valve body 600 that prevents fluid media from escaping from or leaking out of the valve assembly. The directional 400 generally includes the same fluid passage as that utilized in the directional 100. Thus, the operation of the directional 400 within the valve body 600 is similar to that previously described in relation to FIGS. 18A-18D.

All directional references (e.g., proximal, distal, upper, lower, upward, downward, left, right, lateral, front, back, top, bottom, above, below, vertical, horizontal, clockwise, and counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A multiple port valve comprising
a valve body including
an outer circumferential wall;
an inner circumferential surface that defines a cylindrical cavity surrounded by the valve body, the inner circumferential surface having a plurality of openings; and
a plurality of ports extending outward from the outer circumferential wall, each port defining a lumen that extends between one of the plurality of openings in the inner circumferential surface and an opening in a distal end of the respective port; and
a directional component positioned in the cavity and having a sealing surface engaged with the inner circumferential surface to provide a fluid-tight seal between the directional component and the valve body, the directional component defining a passage that extends across an inner portion of the directional component and that provides fluid communication between combinations of two or more of the plurality of ports depending upon an angular orientation of the directional component within the cavity, the passage having opposed sidewalls that converge over at least a portion of the passage.

2. The multiple port valve of claim 1, wherein the passage is formed as a V-shaped funnel.

3. The multiple port valve of claim 1, wherein the passage is formed as a Y-shaped funnel.

4. The multiple port valve of claim 1, wherein the passage is formed as a peace sign.

5. The multiple port valve of claim 1, wherein the passage is formed as three or more conduits that converge in fluid communication at inner ends and extend from a point of convergence to open in an outer surface of the directional component.

6. The multiple port valve of claim 5, wherein the conduits extend substantially radially outward from the point of convergence.

7. The multiple port valve of claim 5, wherein the conduits angularly separate from each other from the point of convergence.

8. A multiple port valve comprising
a valve body having
an outer wall;
an inner wall;
an inner cylindrical cavity defined by the inner wall; and
three or more ports extending from the outer wall that define respective conduits extending between openings in the outer wall and openings in distal ends of the ports; and
a directional component positioned in the cavity, the directional component defining a fluid-flow pathway in an interior portion of the directional component that selectively provides fluid communication between combinations of two or more of the ports depending upon an angular orientation of the directional component within the cavity.

9. The multiple port valve of claim 8, wherein the fluid-flow pathway has an inlet that remains in fluid communication with one of the three or more ports throughout an angular operating range.

10. The multiple port valve of claim 9, wherein the fluid-flow pathway has an outlet that intermittently aligns with individual ports of the three or more ports throughout the angular operating range.

11. The multiple port valve of claim 10, wherein the fluid-flow pathway converges from the inlet towards a centerline of the directional component.

12. The multiple port valve of claim 11, wherein the fluid-flow pathway has a substantially uniform cross-sectional area from the centerline of the directional component towards the outlet.

13. The multiple port valve of claim 11, wherein the fluid-flow pathway converges from the centerline of the directional component towards the cutlet.

14. The multiple port valve of claim 8, wherein the fluid-flow pathway includes three inlet pathways that converge into a common outlet pathway.

15. A multiple port valve comprising
a valve body having a cylindrical inner wall that defines an inner cavity, the valve body defining three or more lumens extending through the inner wall and opening to the inner cavity; and
a directional component rotatably positioned in the inner cavity, the directional component including an outer surface that is press fit into the inner cavity and conforms to the shape of the inner wall of the valve body to create a fluid-tight seal between the directional component and the valve body, the directional component defining a single fluid passage extending through the directional component and opening through the outer surface of the directional component, the fluid passage selectively providing fluid communication between a first of the lumens and each of the other lumens individually depending upon a rotational orientation of the directional component relative to the valve body.

16. The multiple port valve of claim 15, wherein the valve body includes a mounting ear extending from an outer sidewall of the valve body.

17. The multiple port valve of claim 15, wherein the directional component further comprises multiple inwardly-deformable segments that at least partially axially secure the directional component to the valve body.

18. The multiple port valve of claim 15, wherein the directional component further comprises a keyed portion configured to engage a tool or implement to facilitate rotating the directional component relative to the valve body.

19. The multiple port valve of claim 15, wherein
the directional component further defines an interior cavity, and
the fluid passage is defined by a fluid passage body that extends through the interior cavity and separates the interior cavity into two sub-cavities opening to opposing ends of the directional component.

20. The multiple port valve of claim 15, wherein the valve body and the directional component are formed from plastic, resulting in a plastic-to-plastic seal between the inner wall of the valve body and the outer surface of the directional component.

21. A multiple port valve comprising
a valve body having
an outer wall;
an inner wall;
an inner cylindrical cavity defined by the inner wail; and
three or more ports extending from the outer wall that define respective conduits extending between openings in the outer wall and openings in distal ends of the ports; and
a directional component positioned in the cavity, the directional component defining a fluid-flow pathway in an interior portion of the directional component that selectively provides fluid communication between combinations of two or more of the ports depending upon an angular orientation of the directional component within the cavity, the pathway including one or more sidewalls having an arcuate cross-sectional shape, the one or more sidewalls extending between and terminating at inlet and outlet openings formed in a sealing surface of the directional component.

22. The multiple port valve of claim 21, wherein the pathway is formed as a V-shaped funnel.

23. The multiple port valve of claim 21, wherein the pathway is formed as a Y-shaped funnel.

24. The multiple port valve of claim 21, wherein the pathway includes three inlet branches that converge into a single outlet path.

25. The multiple port valve of claim 21, wherein the pathway includes a plurality of inlets and a single outlet.
